(19) United States
(12) Patent Application Publication
(10) Pub. No.: US 2025/0046952 A1
(43) Pub. Date: Feb. 6, 2025

(54) Electrode Assembly and Method of Manufacturing Electrode Assembly

(71) Applicant: LG Energy Solution, Ltd., Seoul (KR)

(72) Inventors: Jea Bong Jung, Daejeon (KR); Chang Bum Ahn, Daejeon (KR); Sang Jin Seo, Daejeon (KR); Dong Guk Sim, Daejeon (KR); Yeong Cheol Jang, Daejeon (KR)

(73) Assignee: LG Energy Solution, Ltd., Seoul (KR)

(21) Appl. No.: 18/289,712

(22) PCT Filed: Jul. 1, 2022
(86) PCT No.: PCT/KR2022/009499

§ 371 Date: May 1, 2024

(30) Foreign Application Priority Data
Jul. 2, 2021 (KR) 10-2021-0087138

(51) Int. Cl. H01M 50/46; H01M 10/04; H01M 50/103

(52) U.S. Cl. CPC H01M 50/46; H01M 10/0413; H01M 50/103

(57) ABSTRACT

The present invention relates to an electrode assembly and a method of manufacturing an electrode assembly, wherein the electrode assembly according to one example of the present invention comprises an electrode stack part, in which a basic unit cell obtained by sequentially laminating a separator, a first electrode, a separator, and a second electrode is laminated numerously in two or more layers, and an electrode fixing part, by which the electrode stack part is surrounded and fixed, having a plurality of through-holes.

### TECHNICAL FIELD

The present invention relates to an electrode assembly and a method of manufacturing an electrode assembly.

This application claims the benefit of priority based on Korean Patent Application No. 10-2021-0087138 dated Jul. 2, 2021, the disclosure of which is incorporated herein by reference in its entirety.

### BACKGROUND ART

Secondary batteries also attract attention as a power source of electric vehicles (EVs), hybrid electric vehicles (HEVs), parallel hybrid electric vehicles (PHEVs), and the like that are proposed as a way to solve air pollution from existing gasoline and diesel vehicles, and the like using fossil fuels, where medium-to-large battery modules electrically connecting a number of battery cells are used due to the need for high output and large capacity in medium-to-large devices such as automobiles.

However, since it is preferable that the medium-to-large battery modules are manufactured as small and light as possible, rectangular batteries, pouch-type batteries, and the like that can be charged with a high integration degree and are lightweight compared to their capacity are mainly used as battery cells of the medium-to-large battery module.

An electrode assembly is accommodated in a case of the battery cells, which is generally classified according to what structure the electrode assembly having a positive electrode/separator/negative electrode structure has.

Typically, it can be classified into a jelly-roll (winding type) electrode assembly having a structure in which long sheet-type positive and negative electrodes are wound with a separator interposed therebetween, a stack-type (lamination-type) electrode assembly in which a number of positive electrodes and negative electrodes cut into units of a predetermined size are sequentially laminated with a separator interposed therebetween, and a stack/folding-type electrode assembly.

The stack/folding-type electrode assemblies disclosed in the present applicant's Korean Laid-Open Patent Publication Nos. 2001-0082058, 2001-0082059, and 2001-0082060 have a full cell, which is a structure in which positive electrode/separator/negative electrode are sequentially laminated, as a unit cell, and are manufactured by repeatedly winding a long separator sheet by a unit length in a state where a plurality of full cells is disposed on the separator sheet.

In the case of such a stack/folding-type electrode assembly, the outer shell of all full cells is surrounded by the separator sheet, so that the relative positions between the respective layers constituting the structure of the electrode assembly are fixed.

FIGS. 1 and 2 are diagrams for explaining a taping structure of a stack-type electrode assembly according to the prior art.

Unlike the stack/folding-type electrode assembly, the relative position between the electrode and the separator is not fixed, so that the side of the electrode assembly is taped using a tape to fix the relative positions between the respective layers. As shown in FIGS. 1 and 2, conventionally, the tapes (21, 22) surround the stack-type electrode body in a band shape.

Referring to FIG. 2, in the stack-type electrode assembly, a positive electrode (11), a separator (12), and a negative electrode (13) are sequentially laminated. The separator (12) is disposed between the positive electrode (11) and the negative electrode (13), and prevents an electrical short circuit due to physical contact between the positive electrode (11) and the negative electrode (13).

In the case of such a stack-type electrode assembly, in general, the separator (12) is manufactured to have wider horizontal and vertical widths than the electrodes (11, 13), and the stack-type electrode assembly is manufactured by repeatedly performing a step of laminating the separator on a magazine or jig having a width corresponding to the horizontal or vertical width of the separator, and laminating an electrode thereon.

The tapes (21, 22) are taped while enclosing the outer surface of the stack-type electrode body, and at this time, as the ends of the tapes overlap, a step is generated by the overlapping thickness of the tapes. Due to the step caused by the taping, defects due to lithium precipitation occur in the step portion (see A of FIG. 1).

In addition, the conventional stack-type electrode body does not block the inflow of foreign substances to the side, so that when foreign substances are introduced into the stack-type electrode body in the course of use, there has been a problem that a low voltage defect due to foreign substances occurs.

### DISCLOSURE

### Technical Problem

The present invention has been devised to solve the above problems, which is intended to provide an electrode assembly capable of preventing lithium precipitation occurring in a pressure-sensitive adhesive portion between an electrode fixing part and an electrode stack part by removing, in a conventional process of fixing an electrode assembly using a pressure-sensitive adhesive tape, a step occurring in the contact surface between the pressure-sensitive adhesive tape and the electrode assembly and an overlapping step between the pressure-sensitive adhesive tapes, and a method of manufacturing an electrode assembly.

Also, the present invention is intended to provide an electrode assembly capable of promoting slimming of the electrode assembly by taping an electrode stack part, in a state where among separators disposed between a plurality of electrodes, the separator disposed on the upper portion of an electrode stack part is removed, in such a way that both ends of an electrode fixing part adhere to the separator disposed on the lower surface of the electrode stack part without overlapping each other while the electrode fixing part surrounds the upper surface and both side surfaces of the electrode stack part to reduce a thickness of the electrode assembly, and a method of manufacturing an electrode assembly.

In addition, the present invention is intended to provide an electrode assembly capable of easily injecting an electrolyte into the electrode assembly through a through-hole provided in a mesh-type electrode fixing part by taping an electrode stack part by the electrode fixing part, and a method of manufacturing an electrode assembly.

Furthermore, the present invention is intended to provide an electrode assembly capable of securing, in a jig formation process for the electrode assembly, uniformity of a J/F surface pressure applied to the electrode assembly by taping an electrode stack part while a mesh-type electrode fixing part covers the entire upper surface of the electrode stack part, and a method for manufacturing an electrode assembly.

In addition, the present invention is intended to provide an electrode assembly, in which an electrode fixing part tapes the entire area of both side surfaces of an electrode stack part in a portion where a lead tab does not exist, thereby preventing inflow of foreign substances into the electrode assembly during an activation process, and a method of manufacturing an electrode assembly.

### Technical Solution

In order to solve the above-described problems, according to one example of the present invention, an electrode assembly comprising an electrode stack part, in which a basic unit cell obtained by sequentially laminating a separator, a first electrode, a separator, and a second electrode is laminated numerously in two or more layers, and an electrode fixing part, by which the electrode stack part is surrounded and fixed, having a plurality of through-holes is provided.

Also, the electrode fixing part may be provided so that it covers the entire upper surface of the electrode stack part, and both ends of the electrode fixing part cover a portion of the lower surface of the electrode stack part.

In addition, the electrode fixing part may be fixed to the electrode stack part so that while it covers the second electrode positioned on the upper portion of the electrode stack part, both ends of the electrode fixing part cover a portion of the separator positioned on the lower portion of the electrode stack part.

Specifically, when two or more basic unit cells are laminated, the electrode fixing part may be fixed to the electrode stack part so that while it covers the second electrode positioned at the top of the electrode stack part, both ends of the electrode fixing part cover a portion of the separator positioned at the bottom of the electrode stack part.

Furthermore, the electrode fixing part may be a pressure-sensitive adhesive sheet having insulation properties.

In addition, the plurality of through-holes may be provided in an area range of 80% to 90% relative to the total area of the electrode fixing part. That is, the total area of the plurality of through-holes may be 80% to 90% relative to the total area of the electrode fixing part.

Also, the plurality of through-holes may be arranged to be uniformly spaced apart. For example, all of the plurality of through-holes may have the same diameter. Also, all the spacings between two adjacent through-holes may be the same. Also, the electrode fixing part may be provided with respect to the total area so that all the numbers of through-holes per unit area of the electrode fixing part are the same. As such, the electrode fixing part may be provided in a uniform pattern over the entire area of the plurality of through-holes.

Also, the electrode fixing part may be a pressure-sensitive adhesive sheet comprising a polyethyleneterephthalate (PET) material.

In addition, the electrode stack part may further comprise a first lead tab electrically connected to the first electrode and a second lead tab electrically connected to the second electrode.

Furthermore, the electrode fixing part may be provided so that it surrounds the side surfaces of the electrode stack part on which the first lead tab and the second lead tab are not installed, but covers the entire upper surface (the second electrode at the top) of the electrode stack part, and both ends of the electrode fixing part cover a portion of the lower surface (the separator at the bottom) of the electrode stack part.

According to another aspect of the present invention, a method of manufacturing an electrode assembly comprising a step S1 that an electrode stack part is provided, in which a basic unit cell obtained by sequentially laminating a separator, a first electrode, a separator, and a second electrode is laminated numerously in two or more layers, a step S2 that an electrode fixing part covers the entire upper surface of the electrode stack part, but is positioned on the upper surface of the electrode stack part so that both ends thereof protrude into the outward direction of the electrode stack part, and a step S3 that the electrode fixing part contacts both side surfaces of the electrode stack part while both ends thereof are pushed down toward the lower portion of the electrode stack part, and is fixed to the lower surface of the electrode stack part is provided.

Also, in the step S3, the electrode fixing part may be fixed to the separator positioned on the lower portion of the electrode stack part while bending the separators protruding into both side surfaces of the electrode stack part toward the lower portion of the electrode stack part in the process of being pushed down toward the lower portion of the electrode stack part, and surrounding both side surfaces of the electrode stack part.

In addition, in the step S3, the electrode fixing part may be provided so that it covers the entire upper surface of the electrode stack part, and both ends of the electrode fixing part cover a portion of the lower surface of the electrode stack part.

Furthermore, in the step S3, the electrode fixing part may be fixed to the electrode stack part so that while it covers the second electrode positioned on the upper portion of the electrode stack part, both ends of the electrode fixing part cover a portion of the separator positioned on the lower portion of the electrode stack part.

In addition, the electrode fixing part may be provided with a plurality of through-holes over the entire area, and the plurality of through-holes may be provided in an area range of 80% to 90% relative to the total area of the electrode fixing part.

Furthermore, the electrode fixing part may be a pressure-sensitive adhesive sheet having insulation properties.

### Advantageous Effects

As discussed above, accordingly, the electrode assembly and the method for manufacturing an electrode assembly related to one example of the present invention have the following effects.

The present invention can prevent lithium precipitation occurring in a pressure-sensitive adhesive portion between an electrode fixing part and an electrode stack part by removing, in a conventional process of fixing an electrode assembly using a pressure-sensitive adhesive tape, a step occurring in the contact surface between the pressure-sensitive adhesive tape and the electrode assembly and an overlapping step between the pressure-sensitive adhesive tapes.

Also, it can promote slimming of the electrode assembly by taping an electrode stack part, in a state where among separators disposed between a plurality of electrodes, the separator disposed on the upper portion of an electrode stack part is removed, in such a way that both ends of an electrode fixing part adhere to the separator disposed on the lower surface of the electrode stack part without overlapping each other while the electrode fixing part surrounds the upper surface and both side surfaces of the electrode stack part to reduce a thickness of the electrode assembly.

In addition, it can facilitate injection of an electrolyte into the electrode assembly, because the electrolyte can be injected into the electrode assembly through a through-hole provided in a mesh-type electrode fixing part by taping an electrode stack part by the electrode fixing part, and a method of manufacturing an electrode assembly.

Furthermore, it can secure, in a jig formation process for the electrode assembly, uniformity of a J/F surface pressure applied to the electrode assembly by taping an electrode stack part, while a mesh-type electrode fixing part covers the entire upper surface of the electrode stack part, to remove the step due to conventional taping on the upper surface of the electrode stack part.

In addition, it can prevent inflow of foreign substances into the electrode assembly during an activation process, as an electrode fixing part tapes the entire area of both side surfaces of an electrode stack part in a portion where a lead tab does not exist.

From such effects, the present invention can increase product production efficiency by ultimately lowering the defect rate of the electrode assembly and simultaneously increasing the production rate of the electrode assembly having excellent performance.

### DESCRIPTION OF DRAWINGS

FIGS. 1 and 2 are diagrams for explaining a taping structure of a stack-type electrode assembly according to the prior art.

FIG. 3 schematically illustrates a perspective diagram of an electrode assembly according to one example of the present invention.

FIG. 4 schematically illustrates a cross-sectional diagram of an electrode assembly taken along a cross-section C-C of FIG. 3.

FIG. 5 schematically illustrates a plan view of an electrode fixing part according to one example of the present invention.

FIG. 6 is a photograph showing the surface pressure distribution applied to the upper surface of the electrode assembly during the jig formation process for the conventional electrode assembly.

FIG. 7 is a photograph showing the surface pressure distribution applied to the upper surface of the electrode assembly during the jig formation process for the electrode assembly according to one example of the present invention.

FIG. 8 is diagrams for explaining a method of manufacturing an electrode assembly according to one example of the present invention.

### MODE FOR INVENTION

Hereinafter, an electrode assembly and a method of manufacturing an electrode assembly according to a preferred example of the present invention will be described with reference to the accompanying drawings.

In addition, regardless of the reference numerals, the same or corresponding components are given the same or similar reference numbers, and overlapping descriptions thereof will be omitted, and the size and shape of each component shown for convenience of description can be exaggerated or reduced.

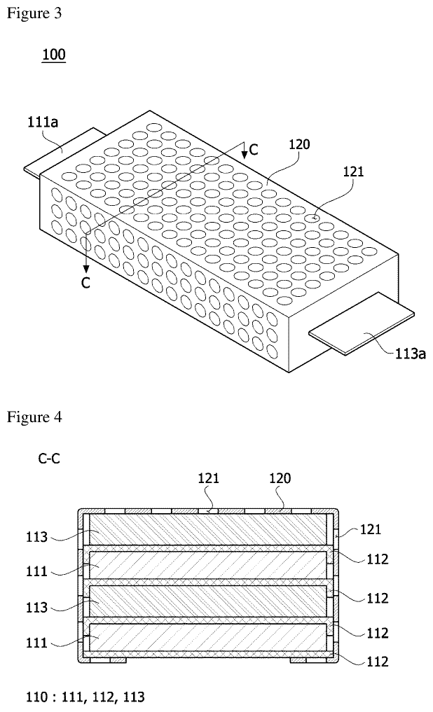

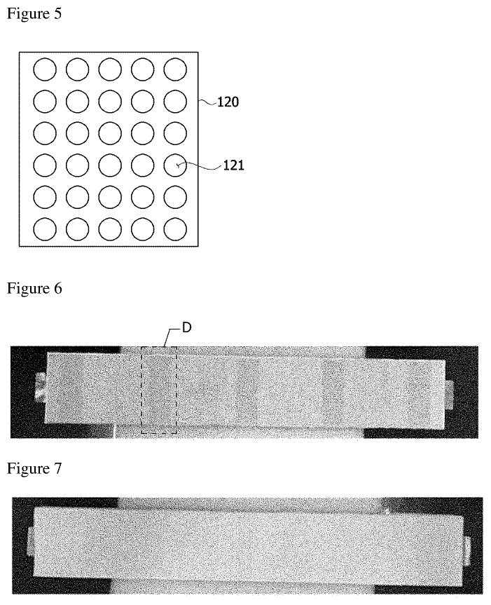

Referring to FIGS. 3 and 4, the electrode assembly (100) comprises an electrode stack part (110) and an electrode fixing part (120).

The electrode stack part (110) is composed of a plurality of first electrodes (111), a plurality of separators (112), and a plurality of second electrodes (113). The electrode stack part (110) comprises a plurality of basic units, and the electrode stack part (110) has a structure in which a plurality of basic unit cells is laminated in two or more layers. In this specification, the basic unit cell comprises a separator (112), a first electrode (111), a separator (112), and a second electrode (113) as one set, and has a structure in which the separator (112), the first electrode (111), the separator (112) and the second electrode (113) are sequentially laminated. As one example, FIG. 4 shows a case in which two basic unit cells are laminated.

Meanwhile, in this document, the upper surface of the electrode stack part means the upper surface of the basic unit cell disposed on the upper portion of the plurality of basic unit cells, and specifically, it means the second electrode located at the top. In addition, the lower surface of the electrode stack part means the lower surface of the basic unit cell disposed on the lower portion of the plurality of basic unit cells, and specifically, it means the separator located at the bottom of the electrode stack part.

The first electrode (111) and the second electrode (113) are electrodes opposite to each other. For example, if the first electrode (111) is a negative electrode, the second electrode (113) refers to a positive electrode. The first electrode (111) is electrically connected to a first lead tab (111a), and the second electrode (113) is electrically connected to a second lead tab (113a).

In the secondary battery, the connection structure of the first electrode (111), the separator (112), the second electrode (113), the first lead tab (111a), and the second lead tab (113a) is a known structure, whereby in this specification, a detailed description thereof will be omitted.

In order to constantly maintain the arrangement state of the electrode stack part (110), that is, the arrangement among the first electrode (111), the separator (112) and the second electrode (113), the electrode fixing part (120) is a component surrounding and fixing the electrode stack part (110).

The electrode fixing part (120) is a pressure-sensitive adhesive sheet having insulation properties. For example, the electrode fixing part (120) may be a pressure-sensitive adhesive sheet made of a polyethylene terephthalate (PET) material.

The electrode fixing part (120) is provided so that it covers the entire upper surface of the electrode stack part (110) and both ends of the electrode fixing part (120) cover a portion of the lower surface of the electrode stack part (110). Specifically, the electrode fixing part (120) is provided so that it surrounds the side surfaces of the electrode stack part (110) on which the first lead tab (111a) and the second lead tab (113a) are not installed, but covers the entire upper surface of the electrode stack part (110), and both ends of the electrode fixing part (120) cover a portion of the lower surface of the electrode stack part (110).

In this example, the electrode fixing part (120) is provided with a plurality of through-holes (121) over the entire area. The plurality of through-holes (121) is provided in an area range of 80% to 90% relative to the total area of the electrode fixing part (120). That is, the total area of the plurality of through-holes may be 80% to 90% relative to the total area of the electrode fixing part.

Also, the plurality of through-holes (121) may be arranged to be uniformly spaced apart on the electrode fixing part. For example, all the plurality of through-holes (121) may have the same diameter. In addition, all the intervals between two adjacent through-holes (121) may be the same. Furthermore, the electrode fixing part (120) may be provided with respect to the total area so that all the numbers of through holes per unit area of the electrode fixing part (120) are the same. As such, the electrode fixing part (120) may be provided in a uniform pattern over the entire area of the plurality of through-holes.

In the present invention, the electrode stack part (110) is taped by a mesh-type electrode fixing part (120) on which a plurality of through-holes is formed, whereby the electrolyte may be injected to the electrode assembly (100) through the through-holes (121) provided in the electrode fixing part (120). That is, the through hole (121) may facilitate injection of the electrolyte into the electrode assembly (100).

In the conventional electrode assembly, the injection of the electrolyte into the portion taped by the tape is blocked, thereby making it difficult to evenly inject the electrolyte over the entire part of the electrode assembly, whereas in the present invention, the injection liquid is supplied to the electrode stack part (110) through the plurality of through-holes (121) provided in the electrode fixing part (120), so that the electrolyte can be evenly injected into the electrode stack part (110).

In addition, the present invention can prevent inflow of foreign substances into the electrode assembly (100) during an activation process, as an electrode fixing part tapes the entire area of both side surfaces of an electrode stack part (110) in a portion where a lead tab does not exist.

Then, in the conventional electrode assembly, the separator (112) is disposed on the upper and lower surfaces of the electrode assembly (100), whereas unlike the prior art, the present invention has a structure that in a state where the separator (112) is removed from the upper portion of the electrode stack part (110), the electrode fixing part (120) surrounds the electrode stack part (110) while covering the entire second electrode (113) positioned on the upper portion of the electrode stack part (110), wherein the electrode fixing part (120) is fixed to the lower surface of the electrode stack part (110) so that both ends of the electrode fixing part (120) do not overlap each other, while replacing the role of the separator (112) and uniformly surrounding the upper surface and the side surfaces of the electrode stack part (110). Here, the lower surface of the electrode stack part (110) corresponds to the separator (112).

The present invention can prevent lithium precipitation occurring in a pressure-sensitive adhesive portion between an electrode fixing part and an electrode stack part by removing, in a conventional process of fixing an electrode assembly using a pressure-sensitive adhesive tape, a step occurring in the contact surface between the pressure-sensitive adhesive tape and the electrode assembly and an overlapping step between the pressure-sensitive adhesive tapes.

Then, the present invention can promote slimming of the electrode assembly by reducing the step caused by overlapping the tapes from each other in the conventional electrode assembly (100), and the thickness of the electrode assembly (100) by the separator (112) thickness according to the removal of the separator (112) placed on the upper portion of the electrode assembly (100), that is, by the overlapping thickness of the tapes and the thickness of the separator (112).

In the conventional electrode stack body, a phenomenon that the separator peels off occurs when the horizontal reciprocating motion, which is a kind of defect rate test, is repeated 2 to 5 times, whereas the electrode assembly of the present invention can perform the horizontal reciprocating motion up to 50 times or more, thereby improving folding defects of the separator. That is, the present invention can increase product production efficiency by ultimately lowering the defect rate of the electrode assembly (100) and simultaneously increasing the production rate of the electrode assembly (100) having excellent performance.

Hereinafter, referring to FIGS. 6 and 7, the surface pressures of the conventional electrode stack body and the electrode assembly of the present invention will be compared during a jig formation process.

The formation process is a process of confirming and activating the capacity of the battery by charging/discharging the battery. The formation process is carried out at room temperature. Since the jig formation process, which is one of the formation processes, proceeds while pressurizing the electrode assembly at a high temperature, there is a problem that if an irregular state surface exists on the surface of the electrode, a uniform pressure is not transmitted to the plate in the jig formation.

Referring to FIGS. 6 and 7, the surface pressures applied to the conventional electrode stack body and the electrode stack body of the present invention during the jig formation process are compared as follows.

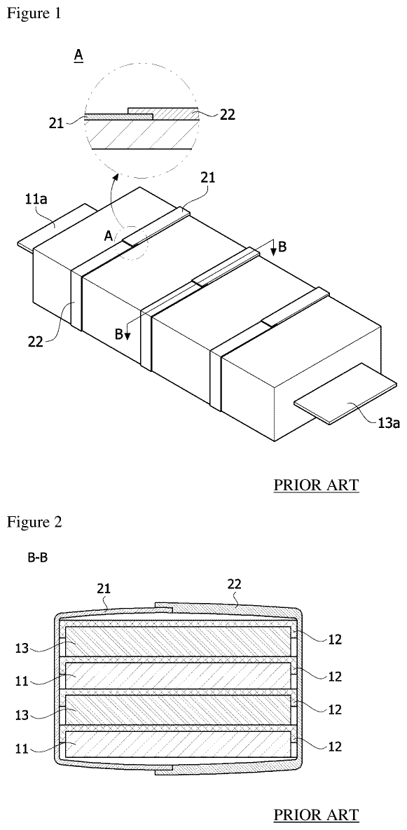

The conventional electrode stack body (see FIG. 1) has a structure that the outer surface of the electrode stack body is taped with a tape to prevent separation of the electrodes. Accordingly, the conventional electrode stack body has a step as much as the thicknesses of the tapes (21, 22), so that the surface pressure applied to the upper surface of the conventional electrode stack body during the jig formation process is not evenly distributed.

Referring to FIG. 6, it can be seen that during the jig formation process, the surface pressure applied to the conventional electrode stack body is concentrated on the tape region (see 21, 22 of FIG. 1) corresponding to the symbol D. FIG. 6 is an experimental image showing the surface pressure distribution applied to the upper surface of the electrode assembly during the jig formation process for the conventional electrode assembly.

On the contrary, in the electrode assembly (100, see FIG. 3) of the present invention, a mesh-type electrode fixing part (120) fixes the electrode stack part (110) while covering the entire upper surface of the electrode stack part (110), so that there is no step on the upper surface of the electrode stack part. Accordingly, during the jig formation process, the J/F (jig formation) surface pressure applied to the electrode assembly (100) of the present invention is uniformly applied.

Referring to FIG. 7, it can be seen that during the jig formation process, the surface pressure applied to the electrode assembly of the present invention is uniformly applied to the upper surface of the electrode stack body, unlike the region D shown in FIG. 6. FIG. 7 is an experimental image of the surface pressure distribution applied to the upper surface of the electrode assembly during the jig formation process for the electrode assembly according to one example of the present invention.

Accordingly, the present invention can remove the step caused by the taping on the upper surface of the conventional electrode stack part (110) as the mesh-type electrode fixing part (120) tapes the electrode stack part (110) while covering the entire upper surface of the electrode stack part (110). Accordingly, the present invention can secure, in the jig formation process for the electrode assembly (100), the uniformity of the J/F (jig formation) surface pressure applied to the electrode assembly (100).

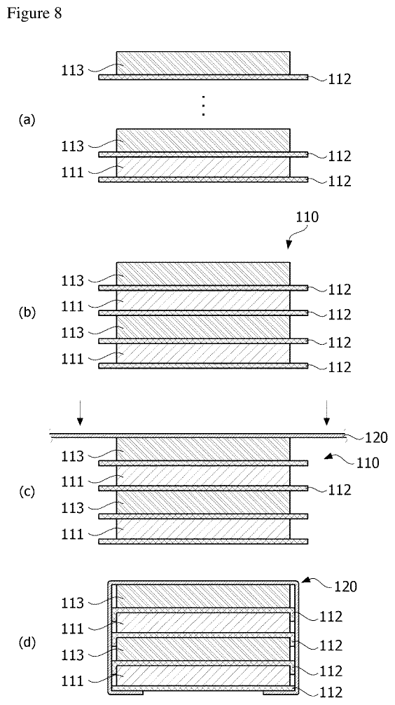

Hereinafter, referring to FIG. 8, a method of manufacturing an electrode assembly according to one example of the present invention will be described.

Referring to FIGS. 8(a) and 8(b), a separator (112), a first electrode (111), a separator (112), and a second electrode (113) are sequentially laminated (step S1). At this time, in this specification, a structure in which the separator (112), the first electrode (111), the separator (112), and the second electrode (113) are sequentially laminated is referred to as a basic unit cell. The electrode stack part (110) refers to a structure in which two or more basic unit cells are laminated numerously.

As shown in FIG. 8(c), the electrode fixing part (120) covers the entire upper surface of the electrode stack part (110), but is positioned on the upper surface of the electrode stack part (110) so that both ends protrude into the outward direction of the electrode stack part (110) (step S2).

Thereafter, as shown in FIG. 8(d), the electrode fixing part (120) contacts both side surfaces of the electrode stack part (110) while both ends thereof are pushed down toward the lower portion of the electrode stack part (110), and is fixed to the lower surface of the electrode stack part (110) (step S3). At this time, as the device for pushing both ends of the electrode fixing part (120) to the lower portion of the electrode stack part (110), a pressurizing member such as a roller may be used.

Also, various types of devices for adhering the electrode fixing part (120) in the form of a pressure-sensitive adhesive sheet to the electrode stack part (110) may be used within a range that is obvious from the standpoint of those skilled in the art.

In the step S3, the electrode fixing part (120) bends the separators (112) protruding into both side surfaces of the electrode stack part (110) toward the lower portion of the electrode stack part (110) in the process of being pushed down toward the lower portion of the electrode stack part (110). In addition, it is preferred that the electrode fixing part (120) is fixed to the separator (112) positioned on the lower portion of the electrode stack part (110) while surrounding both side surfaces of the electrode stack part (110).

In the step S3, the electrode fixing part (120) is adhered to the electrode stack part (110) so that while it covers the second electrode (113) positioned on the upper portion of the electrode stack part (110), both ends of the electrode fixing part (120) cover a portion of the separator (112) positioned on the lower portion of the electrode stack part (110). At this time, the electrode fixing part (120) is adhered to the lower surface of the electrode stack part (110) so as not to overlap each other on the lower surface of the electrode stack part (110). That is, both ends of the electrode fixing part (120) do not cover the entire separator (112) positioned on the lower portion of the electrode stack part (110).

Those having ordinary knowledge in the technical field to which the present invention pertains will understand that the present invention may be embodied in other specific forms without changing the technical spirit or essential features thereof. Therefore, it should be understood that the examples described above are illustrative in all respects and not restrictive.

The scope of the present invention is indicated by the claims to be described below rather than the detailed description, and all changes or modifications derived from the meaning and scope of the claims and their equivalents should be construed as being included in the scope of the present invention.

### INDUSTRIAL APPLICABILITY

The present invention can prevent lithium precipitation occurring in a pressure-sensitive adhesive portion between an electrode fixing part and an electrode stack part by removing, in a conventional process of fixing an electrode assembly using a pressure-sensitive adhesive tape, a step occurring in the contact surface between the pressure-sensitive adhesive tape and the electrode assembly and an overlapping step between the pressure-sensitive adhesive tapes.

1. An electrode assembly characterized by comprising:
an electrode stack part, in which a basic unit cell obtained by sequentially laminating a separator, a first electrode, a separator, and a second electrode is laminated numerously in two or more layers; and
an electrode fixing part, by which the electrode stack part is surrounded and fixed, having a plurality of through-holes.

2. The electrode assembly according to claim 1, characterized in that
the electrode fixing part is provided so that it covers the entire upper surface of the electrode stack part, and both ends of the electrode fixing part cover a portion of the lower surface of the electrode stack part.

3. The electrode assembly according to claim 1, characterized in that the electrode fixing part is fixed to the electrode stack part so that while it covers the
second electrode positioned on the upper portion of the electrode stack part, both ends of the electrode fixing part cover a portion of the separator positioned on the lower portion of the electrode stack part.

4. The electrode assembly according to claim 1, characterized in that
the electrode fixing part is a pressure-sensitive adhesive sheet having insulation properties.

5. The electrode assembly according to claim 1, characterized in that
the plurality of through-holes is provided in an area range of 80% to 90% relative to the total area of the electrode fixing part.

6. The electrode assembly according to claim 1, characterized in that
the plurality of through-holes is arranged to be uniformly spaced apart.

7. The electrode assembly according to claim 1, characterized in that
the electrode fixing part is provided in a uniform pattern over the entire area of the plurality of through-holes.

8. The electrode assembly according to claim 1, characterized in that
the electrode fixing part is a pressure-sensitive adhesive sheet made of a polyethylene terephthalate (PET) material.

9. The electrode assembly according to claim 1, characterized in that
the electrode stack part further comprises a first lead tab electrically connected to the first electrode and a second lead tab electrically connected to the second electrode.

10. The electrode assembly according to claim 9, characterized in that
the electrode fixing part is provided so that it surrounds the side surfaces of the electrode stack part on which the first lead tab and the second lead tab are not installed, but covers the entire upper surface of the electrode stack part, and both ends of the electrode fixing part cover a portion of the lower surface of the electrode stack part.

11. A method of manufacturing an electrode assembly, characterized by comprising:
S1) a step that an electrode stack part is provided, in which a basic unit cell obtained by sequentially laminating a separator, a first electrode, a separator, and a second electrode is laminated numerously in two or more layers:
S2) a step that an electrode fixing part covers the entire upper surface of the electrode stack part, but is positioned on the upper surface of the electrode stack part so that both ends thereof protrude into the outward direction of the electrode stack part; and
S3) a step that the electrode fixing part contacts both side surfaces of the electrode stack part while both ends thereof are pushed down toward the lower portion of the electrode stack part, and is fixed to the lower surface of the electrode stack part.

12. The method of manufacturing an electrode assembly according to claim 11, characterized in that
in the step S3, the electrode fixing part is fixed to the separator positioned on the lower portion of the electrode stack part while bending the separators protruding into both side surfaces of the electrode stack part toward the lower portion of the electrode stack part in the process of being pushed down toward the lower portion of the electrode stack part, and surrounding both side surfaces of the electrode stack part.

13. The method of manufacturing an electrode assembly according to claim 11, characterized in that
in the step S3, the electrode fixing part is provided so that it covers the entire upper surface of the electrode stack part, and both ends of the electrode fixing part cover a portion of the lower surface of the electrode stack part.

14. The method of manufacturing an electrode assembly according to claim 11, characterized in that
in the step S3, the electrode fixing part is fixed to the electrode stack part so that while it covers the second electrode positioned on the upper portion of the electrode stack part, both ends of the electrode fixing part cover a portion of the separator positioned on the lower portion of the electrode stack part.

15. The method of manufacturing an electrode assembly according to claim 11, characterized in that
the electrode fixing part is provided with a plurality of through-holes over the entire area.

16. The method of manufacturing an electrode assembly according to claim 15, characterized in that
the plurality of through-holes is provided in an area range of 80% to 90% relative to the total area of the electrode fixing part.

17. The method of manufacturing an electrode assembly according to claim 11, characterized in that
the electrode fixing part is a pressure-sensitive adhesive sheet having insulation properties.
